(19) United States
(12) Patent Application Publication
(10) Pub. No.: US 2021/0162572 A1
(43) Pub. Date: Jun. 3, 2021

(54) DRIVING TOOL

(71) Applicant: KOKI HOLDINGS CO., LTD., Tokyo (JP)

(72) Inventor: Kazuhiro OOTSUKA, Ibaraki (JP)

(21) Appl. No.: 17/266,005

(22) PCT Filed: Aug. 2, 2019
(86) PCT No.: PCT/JP2019/030469

§ 371 Date: Feb. 4, 2021

(30) Foreign Application Priority Data
Aug. 31, 2018 (JP) 2018-162362

(51) Int. Cl. B25C 1/04; B25C 1/00; B25C 1/06

(52) U.S. Cl. CPC B25C 1/047; B25C 1/06; B25C 1/008

(57) ABSTRACT

A driving tool capable of suppressing the consumption of power for actuating an actuator is provided. The driving tool includes a striking unit, a trigger valve, a housing, a trigger, and a contact member. When an operation force is applied to the trigger and the contact member comes into contact with a workpiece and is actuated, the driving tool switches from the standby state to the actuated state. The driving tool further includes a stopper having a first position where the actuation of the contact member is blocked and a second position where the actuation of the contact member is enabled and an actuator configured to drive the stopper. The actuator holds the stopper at the second position by being supplied with electric power when the stopper is at the second position.

### TECHNICAL FIELD

The present invention relates to a driving tool including a striking unit capable of being actuated to strike a fastener.

### BACKGROUND ART

A driving tool including a striking unit and a driver unit is described in Patent Document 1. The driving tool described in Patent Document 1 has a housing, a pressure accumulation chamber, a pressure chamber, a striking unit, a push lever, a cylinder, a trigger, a trigger valve, and a delay valve as an actuator. The pressure accumulation chamber is provided in the housing, and compressed air is supplied to the pressure accumulation chamber.

In the case where a worker uses the driving tool described in Patent Document 1, if an elapsed time from the time when the worker applies an operation force to the trigger is within a predetermined time, the delay valve connects a passage to supply the compressed gas in the pressure accumulation chamber to the pressure chamber. Therefore, when the push lever is pressed to a workpiece within the predetermined time from the time when the operation force is applied to the trigger, compressed air is supplied to the pressure chamber, and the striking unit is actuated in the direction of striking the fastener.

On the other hand, when the predetermined time has passed from the time when the operation force is applied to the trigger, the delay valve disconnects the passage to supply the compressed gas in the pressure accumulation chamber to the pressure chamber. Therefore, the compressed air is not supplied to the pressure chamber even if the push lever comes into contact with an object other than the workpiece after the predetermined time has passed from the time when the operation force is applied to the trigger. Namely, the striking unit is not actuated in the direction of striking the fastener.

### RELATED ART DOCUMENTS

### Patent Documents

Patent Document 1: International Patent Application Publication No. 2017-115593

### SUMMARY OF THE INVENTION

### Problem to be Solved by the Invention

The inventor of this application has recognized that there is a possibility that the power consumption of an actuator increases when the actuator is actuated by electric power.

An object of the present invention is to provide a driving tool capable of suppressing the power consumed for actuating an actuator.

### Means for Solving the Problems

A driving tool according to an embodiment includes a striking unit configured to strike a fastener, a housing in which the striking unit is provided, an operation member provided on the housing, and a contact member actuated by being pressed to a workpiece into which the fastener is driven, and the driving tool comprises: a stopper having a first position where the actuation of the contact member is blocked and a second position where the actuation of the contact member is enabled; and an actuator configured to drive the stopper, wherein the actuator holds the stopper at the second position by being supplied with electric power when the stopper is at the second position.

### Effects of the Invention

In the driving tool according to an embodiment, it is possible to suppress the power consumed for actuating the actuator.

### BRIEF DESCRIPTION OF THE DRAWINGS

FIG. 1 is a front cross-sectional view showing an overall structure of a driving tool according to an embodiment of the present invention;

FIG. 2 is a cross-sectional view showing the principal part of the driving tool;

FIG. 3(A) is a cross-sectional view showing a mounting structure of a trigger provided in the driving tool and FIG. 3(B) is a schematic diagram showing a state where an operation force is applied to the trigger;

FIG. 4(A) is a schematic diagram showing a state where an operation force is applied to the trigger and a transmission member is actuated and FIG. 4(B) is a schematic diagram showing a state where an operation force is applied to the trigger and the actuation of the transmission member is blocked;

FIG. 5 is a block diagram showing a control system of the driving tool;

FIG. 6 is a flowchart showing a first control example executed in the driving tool;

FIG. 7(A) and FIG. 7(B) are partial cross-sectional views showing another example of a solenoid provided in the driving tool;

FIG. 8 is a flowchart showing a second control example executed in the driving tool;

FIG. 9 is a flowchart showing a third control example executed in the driving tool; and

FIG. 10 is a diagram showing a relationship between a stroke of a plunger and a magnetic attraction force.

### DETAILED DESCRIPTION OF PREFERRED EMBODIMENTS

Next, some driving tools according to embodiments of the present invention will be described with reference to drawings.

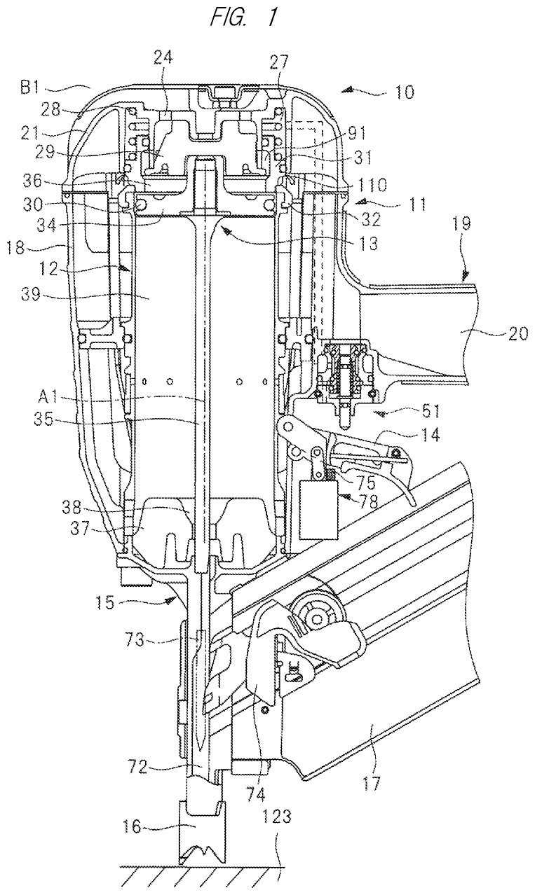

A driving tool 10 shown in FIG. 1 includes a housing 11, a cylinder 12, a striking unit 13, a trigger 14, an ejection unit 15, and a push lever 16. Also, a magazine 17 is attached to the driving tool 10. The housing 11 has a tubular main body 18, a head cover 21 fixed to the main body 18, and a handle 19 connected to the main body 18.

A pressure accumulation chamber 20 is formed across an inside of the handle 19, an inside of the main body 18, and an inside of the head cover 21. A plug is attached to the handle 19. An air hose is connected to the plug. Compressible gas is supplied to the pressure accumulation chamber 20 through the air hose. Air or inert gas can be used as the compressible gas. Examples of the inert gas include nitrogen gas, rare gas, and others. The cylinder 12 is provided in the main body 18. The head cover 21 has an exhaust passage 24. The exhaust passage 24 is connected to an outside B1 of the housing 11.

A head valve 31 is provided in the head cover 21. The head valve 31 can be actuated in the direction of a center line A1 of the cylinder 12. A control chamber 27 is formed in the head cover 21. A biasing member 28 is provided in the control chamber 27. The biasing member 28 is, for example, a metal spring. A stopper 29 is provided in the head cover 21. A valve seat 32 is attached to an end portion of the cylinder 12 that is closest to the head valve 31 in the direction of the center line A1.

The head valve 31 constantly receives the pressure of the pressure accumulation chamber 20, and the head valve 31 is biased in a direction away from the valve seat 32 by the pressure of the pressure accumulation chamber 20. The biasing member 28 biases the head valve 31 toward the valve seat 32 in the direction of the center line A1. A passage 91 is formed between the head valve 31 and the stopper 29. The passage 91 is opened and closed by the actuation of the head valve 31 in the direction of the center line A1. When the passage 91 is closed, a piston upper chamber 36 and the outside B1 are disconnected. When the passage 91 is opened, the piston upper chamber 36 and the outside B1 are connected.

The striking unit 13 includes a piston 34 and a driver blade 35 fixed to the piston 34. The piston 34 is arranged in the cylinder 12. The striking unit 13 can be actuated in the direction of the center line A1 and stopped. A sealing member 30 is attached to an outer peripheral surface of the piston 34. The piston upper chamber 36 is formed between the stopper 29 and the piston 34. A passage 110 is formed between the head valve 31 and the valve seat 32.

When the head valve 31 is separated from the valve seat 32, the passage 110 is opened and the pressure accumulation chamber 20 is connected to the piston upper chamber 36. When the head valve 31 is pressed to the valve seat 32, the passage 110 is closed and the pressure accumulation chamber 20 is disconnected from the piston upper chamber 36. Also, the piston upper chamber 36 is connected to the outside B1 of the housing 11 via the exhaust passage 24.

The ejection unit 15 is fixed to an end portion of the main body 18 on a side opposite to the head cover 21 in the direction of the center line A1. The ejection unit 15 has an ejection path 72. The center line A1 is located in the ejection path 72, and the driver blade 35 is movable in the ejection path 72 in the direction of the center line A1.

A bumper 37 is provided in the cylinder 12. The bumper 37 is arranged at a position closest to the ejection unit 15 in the direction of the center line A1 in the cylinder 12. The bumper 37 has a shaft hole 38, and the driver blade 35 can be actuated in the shaft hole 38 in the direction of the center line A1. In the cylinder 12, a piston lower chamber 39 is formed between the piston 34 and the bumper 37.

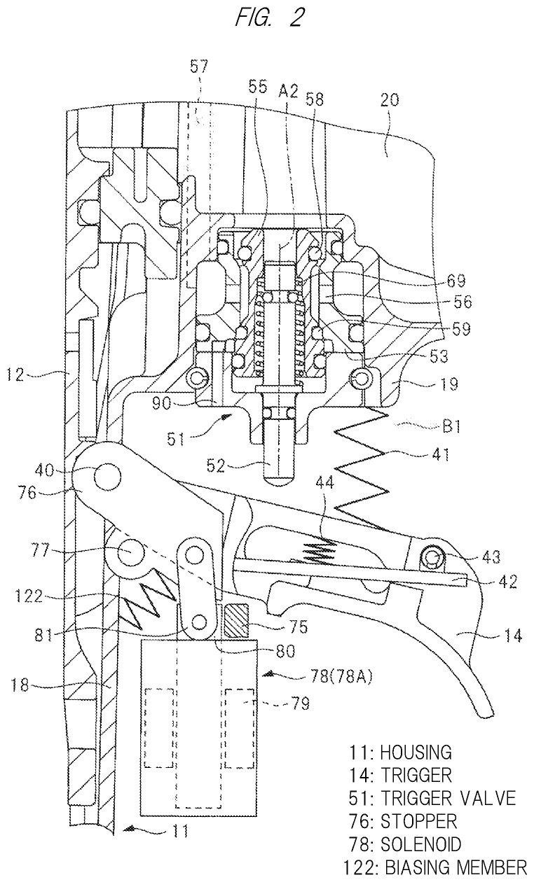

A trigger valve 51 is provided at a connection portion between the main body 18 and the handle 19. As shown in FIG. 2, the trigger valve 51 has a tubular holder 53, a plunger 52, a tubular valve body 55, passages 56 and 90, and a biasing member 69. The holder 53 is fixed to the housing 11. The valve body 55 is arranged in the holder 53. Sealing members 58 and 59 are attached to an outer peripheral surface of the valve body 55. The valve body 55 can be actuated with respect to the holder 53 in the direction of a center line A2.

The passage 56 is connected to the control chamber 27 via a passage 57. The passage 90 is connected to the outside B1 of the housing 11. The plunger 52 is arranged in the valve body 55. The plunger 52 can be actuated with respect to the valve body 55 in the direction of the center line A2. The center line A1 and the center line A2 are parallel to each other. The biasing member 69 is, for example, a compression spring, and the biasing member 69 biases the plunger 52 in the direction away from the pressure accumulation chamber 20 in the direction of the center line A2.

When the valve body 55 is actuated and the sealing member 58 is separated from the holder 53 as shown in FIG. 2, the pressure accumulation chamber 20 and the passage 56 are connected. Also, when the sealing member 58 is pressed to the holder 53, the passage 56 and the passage 90 are disconnected.

When the valve body 55 is actuated and the sealing member 58 is pressed to the holder 53, the pressure accumulation chamber 20 and the passage 56 are disconnected. Also, the sealing member 58 is separated from the holder 53, and the passage 56 and the passage 90 are connected.

The magazine 17 is supported by the ejection unit 15 and the handle 19. The magazine 17 stores fasteners 73. The magazine 17 has a feeder 74, and the feeder 74 sends the fasteners 73 in the magazine 17 to the ejection path 72.

As shown in FIG. 1, the push lever 16 is attached to the ejection unit 15. The push lever 16 can be actuated with respect to the ejection unit 15 and the housing 11 in the direction of the center line A1. A transmission member 75 is connected to the push lever 16. The transmission member 75 can be actuated together with the push lever 16 within a predetermined range in the direction of the center line A2.

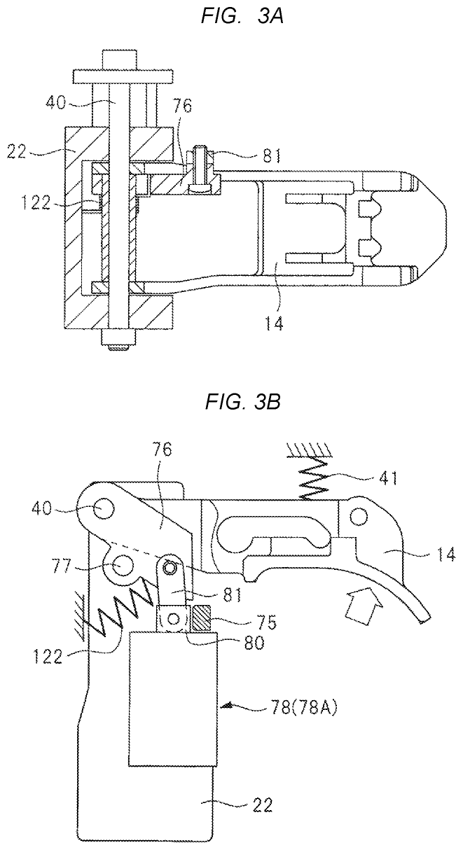

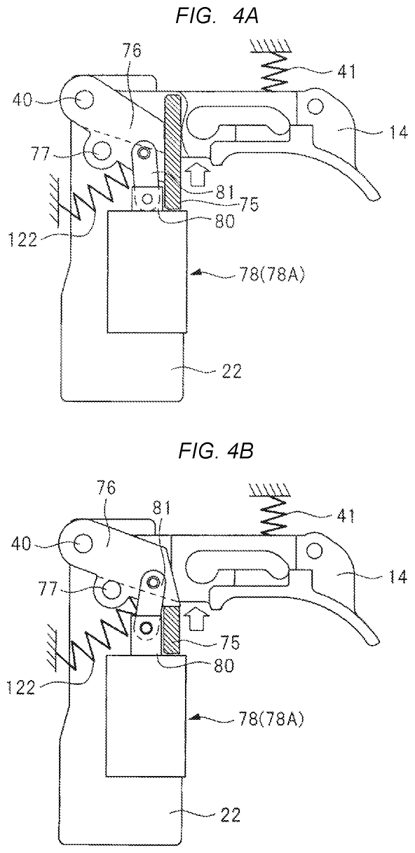

As shown in FIG. 2, FIG. 3(A), FIG. 3(B), FIG. 4(A), and FIG. 4(B), the trigger 14 is attached to a mounting portion 22 via a support shaft 40. The mounting portion 22 is provided so as to protrude from an outer surface of the main body 18. The trigger 14 can be actuated about the support shaft 40 within a predetermined angle range. A biasing member 41 is provided, and the biasing member 41 biases the trigger 14 clockwise in FIG. 2. The biasing member 41 is, for example, a metal spring.

A trigger arm 42 is attached to the trigger 14 via a support shaft 43. The trigger arm 42 can be actuated with respect to the trigger 14 about the support shaft 43 within a predetermined angle range. A biasing member 44 is provided on the trigger 14. The biasing member 44 biases the trigger arm 42 counterclockwise with respect to the trigger 14. The biasing member 44 is, for example, a metal spring. A part of the trigger arm 42 is arranged between the trigger valve 51 and the transmission member 75 in the direction of the center line A2.

A stopper 76 shown in FIG. 2 is attached to the support shaft 40. The stopper 76 can be actuated, that is, is rotatable with respect to the trigger 14 about the support shaft 40 within a predetermined angle range. When the stopper 76 is actuated about the support shaft 40, a part of the stopper 76 enters or exits the actuation range of the transmission member 75. The stopper 76 is made of metal, for example. A contact 77 is provided in the stopper 76. The contact 77 is, for example, a pin.

A biasing member 122 for biasing the stopper 76 is provided. The biasing member 122 biases the stopper 76 counterclockwise about the support shaft 40. The biasing force of the biasing member 122 is less than the biasing force of the biasing member 41. When the stopper 76 is actuated clockwise with respect to the trigger 14, the contact 77 is separated from the trigger 14. When the stopper 76 is actuated counterclockwise with respect to the trigger 14, the contact 77 approaches the trigger 14 and comes into contact with the trigger 14.

A solenoid 78 shown in FIG. 2 is provided in the mounting portion 22 (the mounting portion 22 is shown in FIG. 3(B)). The solenoid 78 is an example of an actuator. The solenoid 78 has a coil 79 and a plunger 80. The plunger 80 can be actuated in a direction parallel to the center line A2. The plunger 80 is made of a magnetic material, for example, iron. The plunger 80 is coupled to the stopper 76 via a link member 81. When electric power is supplied to the solenoid 78, the solenoid 78 generates a magnetic attraction force, so that the solenoid 78 stops the plunger 80. When the power supply to the solenoid 78 is stopped, the solenoid 78 releases the magnetic attraction force.

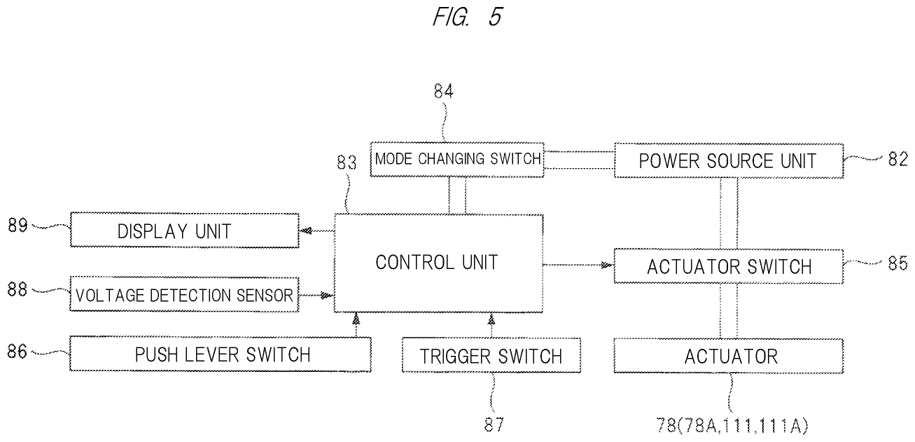

FIG. 5 is a block diagram showing a control system of the driving tool 10. A power source unit 82 is attached to the handle 19 or the magazine 17. The power source unit 82 has a plurality of battery cells. The battery cell is a secondary battery that can be charged and discharged, and any of a lithium ion battery, a nickel hydrogen battery, a lithium ion polymer battery, and a nickel cadmium battery can be used as the battery cell. The battery cell may be a primary battery.

The control unit 83 is provided in the handle 19 or the magazine 17. The control unit 83 is a microcomputer including an input interface, an output interface, an arithmetic processing unit, a memory, and a timer.

A mode changing switch 84 is provided on the handle 19. The worker selects either the first mode or the second mode as the mode for actuating the striking unit 13. The worker operates the mode changing switch 84 to select the first mode or the second mode.

The mode in which the striking unit 13 is actuated by pressing the push lever 16 to a workpiece 123 in the state where the worker is applying an operation force to the trigger 14 (is operating the trigger 14) is the first mode. The first mode can be defined as a continuous firing mode. The mode in which the striking unit 13 is actuated by applying an operation force to the trigger 14 in the state where the worker is pressing the push lever 16 to the workpiece 123 is the second mode. The second mode can be defined as a single firing mode.

When the worker selects the first mode, the mode changing switch 84 is turned on. When the mode changing switch 84 is turned on, the electric power of the power source unit 82 is supplied to the control unit 83, and the control unit 83 is activated. When the worker selects the second mode, the mode changing switch 84 is turned off. When the mode changing switch 84 is turned off, the power supply to the control unit 83 is stopped, and the control unit 83 is stopped.

An actuator switch 85 is provided between the power source unit 82 and the solenoid 78. The control unit 83 controls the on and off of the actuator switch 85. When the control unit 83 turns on the actuator switch 85, the electric power of the power source unit 82 is supplied to the solenoid 78. When the control unit 83 turns off the actuator switch 85, the power supply to the solenoid 78 is stopped. Note that, when the control unit 83 is stopped, the actuator switch 85 is turned off.

Further, a trigger switch 87 is provided in the handle 19 or the main body 18. When the worker applies an operation force to the trigger 14, the trigger switch 87 is turned on. When the worker releases the operation force on the trigger 14, the trigger switch 87 is turned off. Further, a push lever switch 86 is provided in the ejection unit 15. When the push lever 16 is actuated from the initial position with respect to the ejection unit 15, the push lever switch 86 is turned on. When the push lever 16 is stopped at the initial position with respect to the ejection unit 15, the push lever switch 86 is turned off. The signal of the trigger switch 87 and the signal of the push lever switch 86 are input to the control unit 83.

A voltage detection sensor 88 that detects the voltage of the power source unit 82 is provided. The signal of the voltage detection sensor 88 is input to the control unit 83. Further, a display unit 89 is provided. The display unit 89 is provided on, for example, the housing 11 or the handle 19. The display unit 89 is composed of a liquid crystal panel, a light emitting diode lamp, and the like. The control unit 83 controls the display unit 89, and the display unit 89 displays the voltage of the power source unit 82 and the like.

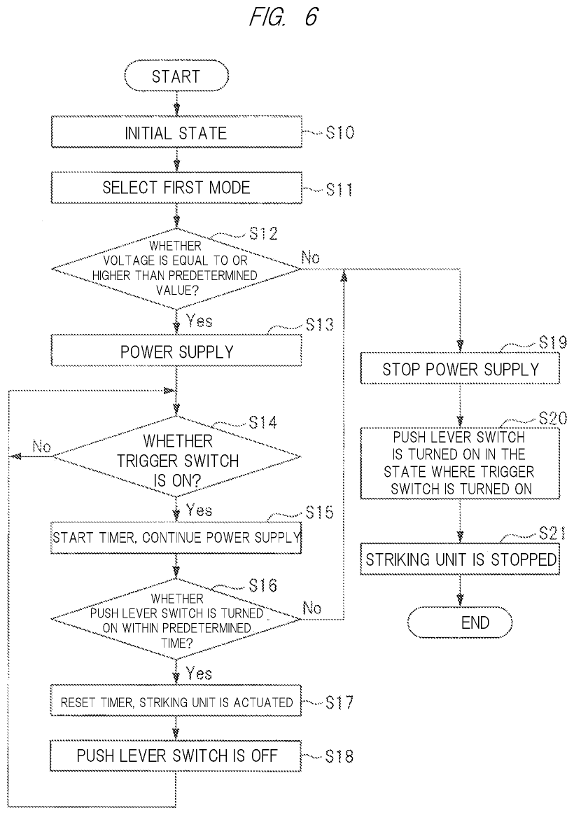

Next, the first control example executed in the driving tool 10 will be described with reference to the flowchart of FIG. 6.

First, the initial state of the driving tool 10 shown in FIG. 1 and step S10 will be described. When the worker releases the operation force on the trigger 14 and separates the push lever 16 from the workpiece 123, the driving tool 10 is in the initial state. The trigger 14 biased by the biasing member 41 is stopped at the initial position shown in FIG. 2, and the trigger arm 42 biased by the biasing member 44 is stopped at the initial position shown in FIG. 2.

When the trigger arm 42 is stopped at the initial position, the trigger valve 51 is stopped in the standby state. In the standby state of the trigger valve 51, the pressure accumulation chamber 20 and the passage 56 are connected, and compressed air is supplied to the control chamber 27. Therefore, the head valve 31 is pressed to the valve seat 32 by the biasing member 28. The head valve 31 closes the passage 110 and opens the passage 91. Therefore, the pressure accumulation chamber 20 and the piston upper chamber 36 are disconnected, and the piston upper chamber 36 and the outside B1 are connected. Accordingly, the striking unit 13 is stopped at the initial position shown in FIG. 1, that is, at the top dead center.

Further, the contact 77 is pressed to the trigger 14 as shown in FIG. 2, and the stopper 76 is stopped at the second position. When the stopper 76 is stopped at the second position, all of the stopper 76 is located outside the actuation range of the transmission member 75. Further, the power supply to the solenoid 78 is stopped, and the plunger 80 is stopped at the second position in FIG. 2.

(Example of Selecting the First Mode)

When the worker selects the first mode in step S11 and the mode changing switch 84 is turned on, the control unit 83 is activated. In step S12, the control unit 83 determines whether or not the voltage of the power source unit 82 is equal to or higher than a predetermined value capable of supplying electric power to the solenoid 78. When the control unit 83 determines Yes in step S12, the control unit 83 supplies the electric power of the power source unit 82 to the solenoid 78 in step S13. The solenoid 78 generates a magnetic attraction force to stop the plunger 80 at the second position shown in FIG. 2.

The control unit 83 determines whether or not the trigger switch 87 is turned on in step S14. When the control unit 83 determines No in step S14, the control unit 83 repeats the determination in step S14. When the control unit 83 determines Yes in step S14, the control unit 83 starts the timer in step S15 and continues to supply electric power to the solenoid 78.

In step S16, the control unit 83 determines whether or not the push lever switch 86 is turned on within a predetermined time from the time when the timer is started. The predetermined time is, for example, 3 seconds. When the control unit 83 determines Yes in step S16, the control unit 83 resets the timer in step S17 and continues to supply electric power to the solenoid 78.

When an operation force is applied to the trigger 14, the trigger arm 42 is actuated clockwise as shown in FIG. 3(B). The biasing force of the biasing member 122 is applied to the stopper 76, but the plunger 80 is stopped at the second position by the magnetic attraction force of the solenoid 78, and the stopper 76 is also stopped at the second position. Therefore, when the worker presses the push lever 16 to the workpiece 123 and the push lever 16 is actuated with respect to the ejection unit 15 from the initial position, the transmission member 75 is actuated in the direction toward the trigger valve 51 as shown in FIG. 4(A).

The actuation force of the transmission member 75 is transmitted to the plunger 52 via the trigger arm 42. Then, the valve body 55 is actuated, and the trigger valve 51 switches from the standby state to the actuated state. When the trigger valve 51 is in the actuated state, the pressure accumulation chamber 20 and the passage 56 are disconnected, and the passage 56 and the passage 90 are connected. Therefore, the compressible gas in the control chamber 27 is discharged to the outside B1 through the passage 90.

Then, the head valve 31 is actuated and separated from the valve seat 32 to open the passage 110, so that the pressure accumulation chamber 20 and the piston upper chamber 36 are connected. Further, the head valve 31 closes the passage 91, so that the piston upper chamber 36 and the external B1 are disconnected. Then, the compressible gas in the pressure accumulation chamber 20 is supplied to the piston upper chamber 36, the striking unit 13 is actuated from the top dead center to the bottom dead center in step S17, and the driver blade 35 strikes the fastener 73. Further, when the control unit 83 detects that the push lever switch 86 is off in step S18, the flow proceeds to step S14.

On the other hand, when the control unit 83 determines No in step S16, the control unit 83 resets the timer in step S19 and stops the power supply to the solenoid 78. Then, the stopper 76 shown in FIG. 3(B) is actuated counterclockwise by the biasing force of the biasing member 122. Further, when the contact 77 comes into contact with the trigger 14, the stopper 76 is stopped at the first position in FIG. 4(B). Note that the actuation force of the stopper 76 is transmitted to the plunger 80 via the link member 81. The plunger 80 is actuated in the direction toward the trigger 14 from the second position, and the plunger 80 is stopped at the first position in FIG. 4(B).

When the stopper 76 is stopped at the first position, a part of the stopper 76 is located within the actuation range of the transmission member 75. Therefore, in step S20, when the push lever 16 comes into contact with a foreign object other than the workpiece 123 to turn on the push lever switch 86 and the transmission member 75 is actuated in the state where the trigger switch 87 is turned on, the transmission member 75 is engaged with the stopper 76 as shown in FIG. 4(B). Namely, the stopper 76 blocks the increase in the actuation amount of the transmission member 75. Therefore, the actuation force of the transmission member 75 is not transmitted to the trigger arm 42, and the trigger valve 51 is held in the standby state.

As described above, when the push lever 16 comes into contact with a foreign object after a predetermined time has passed from the time when the operation force is applied to the trigger 14, the trigger valve 51 is maintained in the standby state and the striking unit 13 is stopped at the top dead center in step S21, and the control example of FIG. 6 ends. Therefore, it is possible to prevent the fastener 73 from being driven into a foreign object.

When the worker releases the operation force on the trigger 14 following step S21, the trigger 14 is actuated clockwise from the actuated position shown in FIG. 4(B) by the biasing force of the biasing member 41, and the trigger 14 returns to the initial position of FIG. 2 and is stopped. Further, the actuation force of the trigger 14 is transmitted to the stopper 76 via the contact 77. Therefore, the stopper 76 is actuated clockwise from the first position shown in FIG. 4(B), and the stopper 76 returns to the second position shown in FIG. 2 and is stopped.

When the control unit 83 determines No in step S12, the flow proceeds to step S19 and the control unit 83 continues to stop the power supply to the solenoid 78.

As described above, the plunger 80 of the solenoid 78 is actuated from the second position to the first position by the biasing force of the biasing member 122, and is actuated from the first position to the second position by the biasing force of the biasing member 41. Namely, it is sufficient if the electric power supplied from the power source unit 82 to the solenoid 78 has a value capable of holding each of the stopper 76 and the plunger 80 at the second position shown in FIG. 3(B) against the biasing force of the biasing member 122. Therefore, it is possible to reduce the power consumed by the solenoid 78. The electric power consumed by the solenoid 78 varies depending on the biasing force of the biasing member 122. Accordingly, the more the biasing force of the biasing member 122 is reduced, the more the electric power consumed by the solenoid 78 can be reduced.

Also, in this embodiment, the stopper 76 is stopped at the second position in the state where the power supply to the solenoid 78 is stopped and the plunger 80 is stopped at the position farthest from the trigger valve 51. Further, a magnetic attraction force is applied to the plunger 80 by supplying electric power to the solenoid 78, and the stopper 76 is held at the second position.

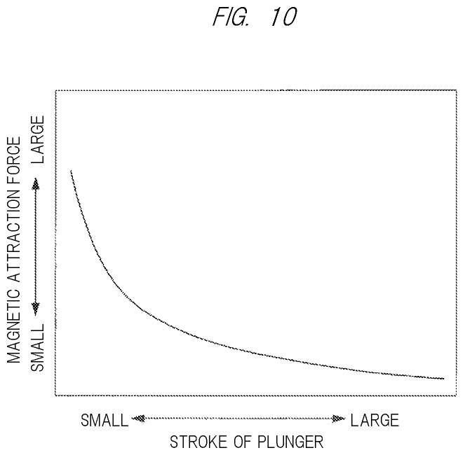

FIG. 10 shows the relationship between the stroke of the plunger 80 and the magnetic attraction force applied to the plunger 80. The stroke of the plunger 80 is the actuation amount of the plunger 80 from the position farthest from the trigger valve 51. The stroke increases as the plunger 80 comes close to the trigger valve 51. In this embodiment, electric power is supplied to the solenoid 78 so that the magnetic attraction force applied to the plunger 80 becomes the maximum value or a value close to the maximum value. Therefore, the solenoid 78 can be downsized and the power consumption of the solenoid 78 can be reduced.

Note that the control unit 83 can perform a process of proceeding from step S18 to step S12 instead of the process of proceeding from step S18 to step S14.

(Example of Selecting the Second Mode)

When the worker selects the second mode and the mode changing switch 84 is turned off in the case where the driving tool 10 is in the initial state of FIG. 1 and step S10, the control unit 83 is stopped, and the power supply to the solenoid 78 is stopped.

Then, when the worker presses the push lever 16 to the workpiece 123, the transmission member 75 is actuated from the initial position. The stopper 76 is stopped at the second position, and all of the stopper 76 is located outside the actuation range of the transmission member 75. Accordingly, the transmission member 75 is not engaged with the stopper 76, and the transmission member 75 comes into contact with the trigger arm 42. Further, when the worker applies an operation force to the trigger 14, the trigger 14 is actuated from the initial position to the actuated position and is stopped. Therefore, the trigger valve 51 switches from the standby state to the actuated state, and the striking unit 13 is actuated from the top dead center to the bottom dead center.

On the other hand, the stopper 76 is biased clockwise by the biasing force of the biasing member 122. However, the stopper 76 comes into contact with the transmission member 75, and this prevents the stopper 76 from being actuated counterclockwise. Also, the plunger 80 is held at the second position.

After the striking unit 13 is actuated from the top dead center to the bottom dead center, the worker releases the operation force on the trigger 14 and separates the push lever 16 from the workpiece 123. Then, the trigger 14 returns from the actuated position to the initial position by the biasing force of the biasing member 41 and is stopped. Also, the trigger 14 comes into contact with the contact 77, and the stopper 76 is held at the initial position by the biasing force of the biasing member 41. When the worker selects the second mode, the striking unit 13 can be actuated from the top dead center to the bottom dead center regardless of the voltage of the power source unit 82.

It is also possible to use an electromagnet 78A instead of the solenoid 78. The electromagnet 78A is configured by winding a coil 79 around a cylinder made of a magnetic material and arranging a plunger 80 in the cylinder so as to be actuatable. When electric power is supplied to the electromagnet 78A, the plunger 80 is stopped at the initial position shown in FIG. 2 by the attraction force of the electromagnet 78A.

(Other Examples of Actuator)

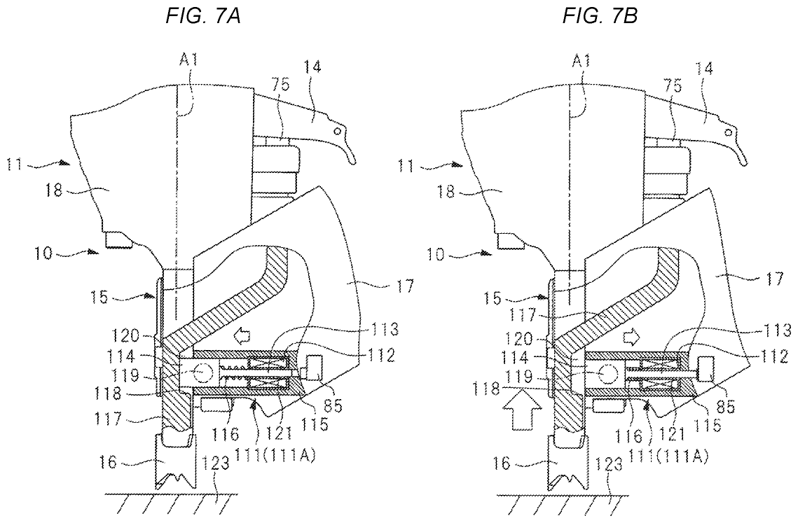

Other examples of the actuator will be described with reference to FIG. 7(A) and FIG. 7(B). A solenoid 111 is provided in the magazine 17. The solenoid 111 has a casing 115, a coil 112, and a plunger 113. A stopper 114 is fixed to the plunger 113. The plunger 113 and the stopper 114 can be linearly actuated within a predetermined range in a direction intersecting the center line A1. Namely, the stopper 114 and the plunger 113 can be actuated in the directions toward and away from the ejection unit 15. A lever 119 is provided on the stopper 114.

A biasing member 116 is provided in the casing 115. The biasing member 116 is, for example, a metal spring. The biasing member 116 biases the stopper 114 in the direction toward the ejection unit 15. The worker can grasp the lever 119 with fingers and actuate the stopper 114 and the plunger 113 in the direction away from the ejection unit 15 against the force of the biasing member 116. An arm 117 for transmitting the actuation force of the push lever 16 to the transmission member 75 is provided. The arm 117 has a concave portion 120 and an engagement portion 118. The arm 117 is actuated in the direction of the center line A1 together with the push lever 16. An actuator switch 85 is provided in the magazine 17.

When the worker grasps the lever 119 with fingers and the stopper 114 is actuated in the direction away from the ejection unit 15, the actuator switch 85 is turned on. When the actuator switch 85 is turned on, electric power of the power source unit 82 is supplied to the solenoid 111.

The control unit 83 has a function of turning off the actuator switch 85. When the actuator switch 85 is turned off and the power supply to the solenoid 111 is stopped, the stopper 114 approaches the arm 117 by the biasing force of the biasing member 116 and is stopped. Note that the mode changing switch 84 shown in FIG. 5 is not provided, and electric power of the power source unit 82 is always supplied to the control unit 83.

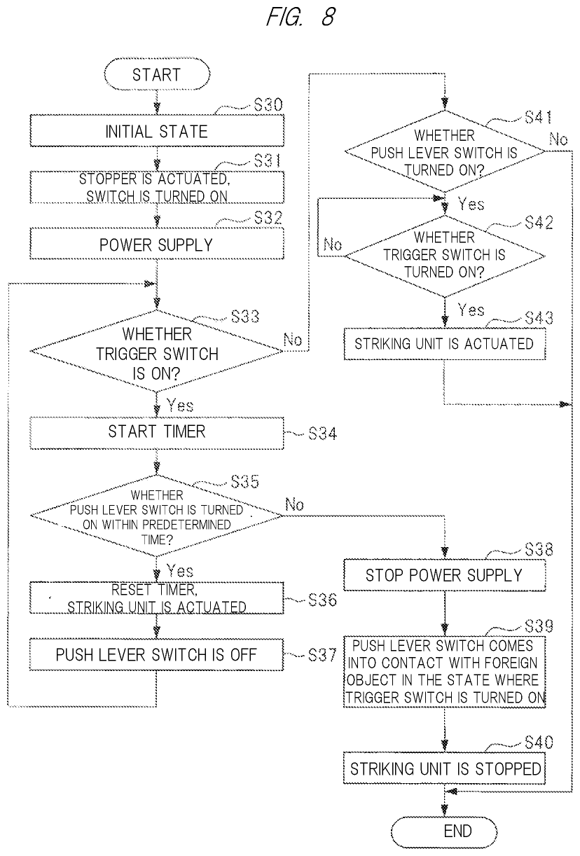

Next, a usage example of the driving tool 10 shown in FIG. 7(A) and FIG. 7(B) will be described with reference to the flowchart of FIG. 8.

When the worker releases the operation force on the trigger 14 and separates the push lever 16 from the workpiece 123, the driving tool 10 is in the initial state shown in step S30 of FIG. 8. Also, the trigger 14 is stopped at the initial position, and the push lever 16 is stopped at the initial position. Further, the trigger valve 51 is stopped in the standby state.

No electric power is supplied to the solenoid 111. The stopper 114 is biased toward the ejection unit 15 by the biasing force of the biasing member 116, and the tip of the stopper 114 is located inside the concave portion 120. When the worker applies an operation force to the lever 119 and actuates the stopper 114 and the plunger 113 in the direction away from the ejection unit 15 as shown in FIG. 7(B), the actuator switch 85 is turned on in step S31.

Electric power is supplied to the solenoid 111 in step S32, and the solenoid 111 stops the plunger 113 and the stopper 114 at the second position shown in FIG. 7(B) by a magnetic attraction force. When the stopper 114 is stopped at the second position, the actuator switch 85 is maintained in an on state. Therefore, even if the worker releases the operation force on the lever 119, the plunger 113 and the stopper 114 are stopped at the second position. All of the stopper 114 stopped at the second position is located outside the concave portion 120.

The control unit 83 determines whether or not the trigger switch 87 is turned on in step S33. When the control unit 83 determines Yes in step S33, the control unit 83 starts the timer in step S34 and continues to supply electric power to the solenoid 111.

In step S35, the control unit 83 determines whether or not the push lever switch 86 is turned on within a predetermined time from the time when the timer is started. Note that the stopper 114 does not hinder the actuation of the push lever 16 and the arm 117. Also, the predetermined time is, for example, 3 seconds.

When the control unit 83 determines Yes in step S35, the control unit 83 resets the timer in step S36 and continues to supply electric power to the solenoid 111. Also, in step S36, the trigger valve 51 switches from the standby state to the actuated state, and the striking unit 13 is actuated from the top dead center to the bottom dead center. Further, when the control unit 83 detects that the push lever switch 86 is off in step S37, the flow proceeds to step S33. Note that the usage mode in which Yes is determined in step S33 and Yes is determined in step S35 is the first mode.

On the other hand, when the control unit 83 determines No in step S35, the control unit 83 resets the timer in step S38, turns off the actuator switch 85, and stops the power supply to the solenoid 111. Then, the stopper 114 shown in FIG. 7(B) is actuated toward the arm 117 by the biasing force of the biasing member 116, so that the tip of the stopper 114 enters the concave portion 120 and the stopper 114 comes into contact with the arm 117 and is stopped at the first position.

Therefore, in step S39, when the push lever 16 comes into contact with a foreign object other than the workpiece 123 in the state where the trigger switch 87 is turned on, the engagement portion 118 is engaged with the stopper 114. Namely, the stopper 114 prevents the increase in the actuation amount of the arm 117. Therefore, the actuation force of the arm 117 is not transmitted to the trigger arm 42, and the trigger valve 51 is held in the standby state. Therefore, the striking unit 13 is stopped at the top dead center in step S40, and the control example of FIG. 8 ends.

As described above, even if the push lever 16 comes into contact with a foreign object after a predetermined time has passed from the time when the operation force is applied to the trigger 14, the trigger valve 51 is maintained in the standby state, and the striking unit 13 is stopped at the top dead center. Therefore, it is possible to prevent the fastener 73 from being driven into the foreign object.

When the control unit 83 determines No in step S33, the control unit 83 determines in step S41 whether or not the push lever switch 86 is turned on. When the control unit 83 determines No in step S41, the control example of FIG. 8 ends.

When the control unit 83 determines Yes in step S41, the control unit 83 determines in step S42 whether or not the trigger switch 87 is turned on. When the control unit 83 determines No in step S42, the control unit 83 repeats the determination in step S42. When the control unit 83 determines Yes in step S42, the trigger valve 51 switches from the standby state to the actuated state in step S43 and the striking unit 13 is actuated from the top dead center to the bottom dead center, and the control example of FIG. 8 ends.

Note that the usage example in which Yes is determined in step S41 and Yes is determined in step S42 is the second mode.

As described above, the stopper 114 and the plunger 113 are each actuated from the first position to the second position by the operation force of the worker. Also, when the power supply to the solenoid 111 is stopped, the stopper 114 and the plunger 113 are each actuated from the second position to the first position by the biasing force of the biasing member 116, and the stopper 114 and the plunger 113 are each stopped at the first position. Therefore, it is sufficient if the electric power supplied from the power source unit 82 to the solenoid 111 has a value capable of holding each of the stopper 114 and the plunger 113 at the second position shown in FIG. 7(B) against the biasing force of the biasing member 116.

Therefore, it is possible to reduce the power consumed by the solenoid 111. The electric power consumed by the solenoid 111 varies depending on the biasing force of the biasing member 116. Accordingly, the more the biasing force of the biasing member 116 is reduced, the more the electric power consumed by the solenoid 111 can be reduced.

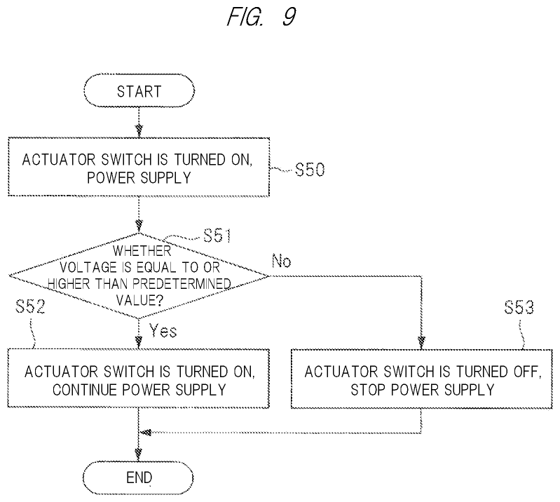

Another control example executed by the control unit 83 in parallel with the control example of FIG. 8 will be described with reference to FIG. 9.

In step S50, the actuator switch 85 is turned on and electric power is supplied to the solenoid 111. In step S51, the control unit 83 determines whether or not the voltage of the power source unit 82 is equal to or higher than a predetermined value. The predetermined value corresponds to the minimum value of the voltage that can be applied to the solenoid 111.

When the control unit 83 determines Yes in step S51, the control unit 83 maintains the actuator switch 85 in an on state and continues to supply electric power to the solenoid 111 in step S52, and the control example of FIG. 9 ends.

When the control unit 83 determines No in step S51, the control unit 83 turns off the actuator switch 85 and stops the power supply to the solenoid 111 in step S53, and the control example of FIG. 9 ends. In step S53, the control unit 83 causes the display unit 89 to display that the voltage of the power source unit is less than the predetermined value.

It is also possible to use an electromagnet 111A instead of the solenoid 111. The electromagnet 111A is configured by winding the coil 112 around a cylinder 121 made of a magnetic material and arranging the plunger 113 in the cylinder 121 so as to be actuatable. When electric power is supplied to the electromagnet 111A, the electromagnet 111A generates an attraction force and the plunger 113 and the stopper 114 are each stopped at the second position shown in FIG. 7(B).

Examples of the technical meanings of the matters disclosed in the embodiments areas follows. The striking unit 13 is an example of a striking unit. The trigger valve 51 and the head valve 31 are examples of a driver unit. The state where the valve body 55 connects the passage 56 and the pressure accumulation chamber 20 and disconnects the passage 56 and the passage 90 is the standby state of the trigger valve 51. The state where the head valve 31 closes the passage 110 is the standby state of the head valve 31.

The state where the valve body 55 disconnects the passage 56 and the pressure accumulation chamber 20 and connects the passage 56 and the passage 90 is the actuated state of the trigger valve 51. The state where the head valve 31 opens the passage 110 is the actuated state of the head valve 31.

The housing 11 is an example of a housing. The trigger 14 is an example of an operation member. The push lever 16 is an example of a contact member.

The pressure accumulation chamber 20 is an example of a pressure accumulation chamber. The piston upper chamber 36 is an example of a pressure chamber. The pressure accumulation chamber and the pressure chamber are spaces that can store the compressible gas. The passage 110 is an example of a passage. The stoppers 76 and 114 are examples of a stopper.

The second position of the stopper 76 shown in FIG. 2 is an example of a second position of the stopper. The first position of the stopper 76 shown in FIG. 4(B) is an example of a first position of the stopper. The first position of the stopper 114 shown in FIG. 7(A) is an example of a first position of the stopper. The second position of the stopper 114 shown in FIG. 7(B) is an example of a second position of the stopper. The biasing members 116 and 122 are examples of a biasing member.

The first position of the stopper is a position where the actuation of the contact member is blocked. Here, blocking the actuation of the contact member means that the actuation amount of the contact member is suppressed to a predetermined value or less. When the actuation amount of the contact member is equal to or less than the predetermined value, the driver unit does not switch from the standby state to the actuated state and is maintained in the standby state. When the actuation amount of the contact member exceeds the predetermined value, the driver unit switches from the standby state to the actuated state.

The solenoids 78 and 111 and the electromagnets 78A and 111A are examples of an actuator. The solenoids 78 and 111 are examples of a solenoid. The electromagnets 78A and 111A are examples of an electromagnet. The plungers 80 and 113 are examples of a plunger. The control unit 83 is an example of a control unit. 3 seconds is an example of a predetermined time, and the predetermined time may exceed 3 seconds.

Step S15 in FIG. 6 is an example of a first control. Step S17 in FIG. 6 is an example of a second control. Step S19 in FIG. 6 is an example of a third control. Step S34 in FIG. 8 is an example of the first control. Step S36 in FIG. 8 is an example of the second control. Step S38 in FIG. 8 is an example of the third control.

The driving tool is not limited to the above-described embodiments, and various modifications can be made without departing from the spirit of the invention. For example, the control unit may be a single electric component or electronic component, or a unit having a plurality of electric components or a plurality of electronic components. Examples of the electric components and the electronic components include a processor, a control circuit, and a module.

The actuator includes a unit in which an electric motor and a rack and pinion mechanism are combined. The pinion is provided on a rotation shaft of the electric motor, and the rack is provided on the stopper. The stopper can be rotated within a predetermined angle range, or can be linearly actuated within a predetermined angle range. It is possible to stop the stopper at the first position by the biasing force of the biasing member without supplying electric power to the electric motor. On the other hand, it is possible to stop the stopper at the second position by supplying electric power to the electric motor to rotate the pinion and actuate the rack. Examples of the passage include a gap and a port.

The housing may be a frame, a body, and a casing. Examples of the operation member include a lever, a knob, and an arm that can be rotated within a predetermined angle range with respect to the housing. Examples of the operation member include a lever, a knob, and an arm that can reciprocate linearly within a predetermined range with respect to the housing. The contact member can reciprocate linearly within a predetermined range with respect to the housing. Examples of the contact member include a lever, an arm, a shaft and a plunger.

Examples of the stopper include a stopper that can be rotated within a predetermined angle range with respect to the housing and a stopper that can reciprocate linearly within a predetermined range with respect to the housing. Examples of the biasing member include a solid spring, a gas spring, and synthetic rubber.

### REFERENCE SIGNS LIST

10 . . . driving tool, 11 . . . housing, 13 . . . striking unit, 14 . . . trigger, 16 . . . push lever, 20 . . . pressure accumulation chamber, 31 . . . head valve, 36 . . . piston upper chamber, 51 . . . trigger valve, 76, 114 . . . stopper, 78, 111 . . . solenoid, 78A, 111A . . . electromagnet, 80, 113 . . . plunger, 83 . . . control unit, 110 . . . passage, 116, 122 . . . biasing member

1-10. (canceled)

11. A driving tool including a striking unit configured to strike a fastener, a housing in which the striking unit is provided, a pressure accumulation chamber formed in the housing and configured to store compressible gas, a pressure chamber formed in the housing and configured to actuate the striking unit when the compressible gas is supplied from the pressure accumulation chamber, a passage configured to supply the compressible gas from the pressure accumulation chamber to the pressure chamber, an operation member provided on the housing, and a contact member actuated by being pressed to a workpiece into which the fastener is driven,
the driving tool being switched between a standby state where the passage is closed and an actuated state where the passage is opened depending on operation states of the operation member and the contact member,
the driving tool comprising:
a stopper actuated to a first position where the actuation of the contact member is blocked when a worker presses the contact member to the workpiece and a second position where the actuation of the contact member is enabled when the worker presses the contact member to the workpiece; and
an actuator configured to drive the stopper,
wherein the actuator holds the stopper at the second position by being supplied with electric power when the stopper is at the second position, and
wherein, in the state where electric power is being supplied to the actuator and the stopper is being held at the second position, the worker operates the operation member and actuates the contact member to make the driving tool be in the actuated state, whereby the compressible gas is supplied from the pressure accumulation chamber to the pressure chamber through the passage and the striking unit is actuated.

12. The driving tool according to claim 11, further comprising a biasing member configured to actuate the stopper from the second position to the first position when the power supply to the actuator is stopped.

13. The driving tool according to claim 12,
wherein the operation member holds the stopper at the second position against a biasing force of the biasing member when an operation on the operation member is released and the power supply to the actuator is stopped, and
wherein the actuator holds the stopper at the second position when the operation on the operation member is released and electric power is supplied to the actuator.

14. The driving tool according to claim 12,
wherein the biasing member holds the stopper at the first position when an operation is applied to the operation member and the power supply to the actuator is stopped.

15. The driving tool according to claim 11,
wherein the actuator is a solenoid configured to generate a magnetic attraction force by being supplied with electric power, and
wherein the solenoid holds the stopper at the second position by the magnetic attraction force.

16. The driving tool according to claim 15,
wherein the solenoid has a plunger stopped by the magnetic attraction force, and
wherein a link member configured to couple the plunger and the stopper is provided.

17. The driving tool according to claim 11,
wherein the actuator is an electromagnet configured to generate an attraction force by being supplied with electric power, and
wherein the electromagnet holds the stopper at the second position by the attraction force.

18. The driving tool according to claim 11,
wherein the stopper is actuated from the first position to the second position by an operation of a worker.

19. The driving tool according to claim 11,
wherein modes to be selected by the worker for actuating the striking unit includes:
a first mode in which the striking unit is actuated by bringing the contact member into contact with the workpiece in the state where the operation is being applied to the operation member; and
a second mode in which the striking unit is actuated by applying the operation to the operation member in the state where the contact member is in contact with the workpiece,
the driving tool further comprising a control unit configured to control supply and stop of electric power to the actuator, and
wherein the control unit executes:
a first control in which electric power is supplied to the actuator when the worker selects the first mode and applies the operation to the operation member;
a second control in which the power supply to the actuator is continued when an elapsed time from the time when the worker applies the operation to the operation member is within a predetermined time; and
a third control in which the power supply to the actuator is stopped when the predetermined time has passed in the state where the electric power is supplied to the actuator and the contact member is separated from the workpiece.

20. A driving tool including a striking unit configured to strike a fastener, a housing in which the striking unit is provided, an operation member provided on the housing, and a contact member actuated by being pressed to a workpiece into which the fastener is driven,
the driving tool comprising:
a stopper having a first position where the actuation of the contact member is blocked and a second position where the actuation of the contact member is enabled; and
an actuator configured to drive the stopper,
wherein the actuator holds the stopper at the second position by being supplied with electric power when the stopper is at the second position, and
wherein the stopper is actuated from the first position to the second position by an operation of a worker.
